(19) United States
(12) Patent Application Publication
(10) Pub. No.: US 2025/0298240 A1
(43) Pub. Date: Sep. 25, 2025

(54) PROJECTION ASSEMBLY COMPRISING A COMPOSITE PANE

(71) Applicant: SAINT-GOBAIN GLASS FRANCE, COURBEVOIE (FR)

(72) Inventors: Jan HAGEN, HERZOGENRATH (DE); Andreas GOMER, HERZOGENRATH (DE)

(21) Appl. No.: 18/860,991

(22) PCT Filed: Apr. 21, 2023
(86) PCT No.: PCT/EP2023/060424

§ 371 Date: Oct. 28, 2024

(30) Foreign Application Priority Data
Apr. 29, 2022 (EP) 22170748.2

(51) Int. Cl. G02B 27/01; G02B 1/14; G02B 27/28

(52) U.S. Cl. CPC G02B 27/0101; G02B 1/14; G02B 27/283; G02B 2027/013; G02B 2027/0194

(57) ABSTRACT

A projection assembly includes a light source for p-polarized light and a composite pane including an outer pane with exterior-side and interior-side surfaces, an inner pane with exterior-side and interior-side surfaces, and a thermoplastic intermediate layer. In at least one first subregion of the composite pane, a reflection layer for reflecting the p-polarized light of the light source is arranged on the interior-side surface of the inner pane and/or the exterior-side surface of the inner pane, directly adjacent the surroundings, the interior-side surface of the inner pane is the surface of the composite pane nearest the light source for p-polarized light, at least one opaque cover layer is arranged at least in a second subregion of the composite pane, and a projection of the first subregion into the plane of the second subregion is at least partially congruent therewith. The reflection layer includes at least one metal carbide-based layer.

The invention relates to a projection assembly, a method for production thereof, and use thereof.

Windshields with functional elements are increasingly being used in the automotive sector. These include, for example, display elements that enable using the glazing as a display while maintaining transparency of the glazing. Such displays enable the driver of a motor vehicle to receive relevant data displayed directly in the windshield of the motor vehicle without having to take his eyes off the road. Applications in buses, trains, or other means of public transportation are also known in which current trip information or advertising is projected onto the glazing.

Frequently used for displaying navigation data in windshields are the projection assemblies known under the term “head-up display (HUD)” consisting of a projector and a windshield with a wedge-shaped thermoplastic intermediate layer and/or wedge-shaped panes. A wedge angle is necessary here to avoid double images. The projected image appears in the form of a virtual image at a certain distance from the windshield such that the driver of the motor vehicle, for example, perceives the projected navigation data as situated on the road in front of him. The radiation from HUD projectors is typically essentially s-polarized, due to the better reflection characteristics of the windshield compared to p-polarization. However, if the viewer wears polarization-selective sunglasses that transmit only p-polarized light, the HUD image is perceived as weakened. One solution to this problem is the use of projection assemblies that use p-polarized light. DE102014220189A1 discloses a head-up display projection assembly that is operated with p-polarized radiation, wherein the windshield has a reflecting structure that reflects p-polarized radiation toward the viewer. US20040135742A1 also discloses a head-up display projection assembly using p-polarized radiation, which has a reflecting structure. In WO 96/19347A3, a multi-ply polymer layer is proposed as the reflecting structure.

Another known concept for displaying data on a pane is the integration of display films based on diffuse reflection. These generate a real image that appears to the viewer in the plane of the glazing. Glazings with transparent display films are known, for example, from EP 2 670 594 A1 and EP 2 856 256 A1. The diffuse reflection of the display element is produced by means of a rough internal surface and a coating situated thereon. EP 3 151 062 A1 describes a projection assembly for integration in an automobile glazing.

The windshield of a motor vehicle can thus be used simultaneously as a projection surface for a virtual HUD image and a real image based on diffuse reflection. These different projection technologies are also used to relocate displays such as the speedometer, warnings, or vehicle data, which are conventionally integrated into the dashboard of a vehicle, to the windshield. However, a large number of large-area projections on the windshield can be a nuisance for the driver. Moreover, the projectors used for head-up displays must have a appropriately strong power to ensure that the projected image has sufficient brightness even with backlighting and can be easily recognized by the viewer. Such projectors have comparatively high energy consumption.

JP S63 275060 A relates to a magneto-optical recording medium.

EP 1180710 A2 describes a head-up display system that includes a transparent pane, a liquid crystal display, and a laminate comprising first and second λ/4 films.

WO 2022/073894 A1 discloses a vehicle pane for a head-up display comprising at least one transparent pane with a masking strip in an edge region of the pane and a reflection layer applied by a printing method, which is applied in the region of the masking strip toward the vehicle interior relative thereto.

Accordingly, there is a need for projection assemblies that have good contrast of the image generated, even with backlighting, as well as low energy consumption, can be operated with p-polarized light, and have high reflectivity for p-polarized light. The object of the present invention is to provide such an improved projection assembly and a method for its production.

This object is accomplished according to the invention by a projection assembly in accordance with claim 1. Preferred embodiments are apparent from the dependent claims.

The projection assembly according to the invention comprises a composite pane and a light source for p-polarized light. The composite pane comprises an outer pane with an exterior-side surface (side I) and an interior-side surface (side II), an inner pane with an exterior-side surface (side III) and an interior-side surface (side IV), and a thermoplastic intermediate layer joining the interior-side surface of the outer pane to the exterior-side surface of the inner pane. The composite pane has at least one first subregion in which a reflection layer is arranged on the interior-side surface of the inner pane and/or on the exterior-side surface of the inner pane. The reflection layer is suitable for reflecting p-polarized light and includes at least one metal carbide-based layer, which is arranged on the interior-side surface of the inner pane. The composite pane further has at least one opaque cover layer in at least a second subregion of the composite pane, which is arranged on the exterior-side surface of the outer pane, on the interior-side surface of the outer pane, on the exterior-side surface of the inner pane, and/or on the interior-side surface of the inner pane. The opaque cover layer can be arranged indirectly or directly on the surface of the pane. The distance of the reflection layer from the light source of the projection assembly is less than the distance of the opaque cover layer from the light source. In other words, in the installed state of the projection assembly in a vehicle, the reflection layer is arranged inward toward the interior relative to the opaque cover layer, i.e., the reflection layer is closer to the vehicle interior. A projection of the first subregion, in which the reflection layer is situated, into the plane of the second subregion is at least partially congruent therewith. Accordingly, the reflection layer is arranged at least partially in the region of the opaque cover layer such that there is an overlapping region of these layers. In the installed state of the projection assembly in a vehicle, the reflection layer is less distant from the vehicle interior than the opaque cover layer. The light source for p-polarized light is arranged on the side of the interior-side surface of the inner pane and is thus situated in the vehicle interior in the installed state of the projection assembly in a vehicle. Accordingly, light from the light source emanating from the vehicle interior strikes the reflection layer of the composite pane and is reflected there. The reflected light is recognizable as an image for a viewer situated in the vehicle interior. From the perspective of the viewer in the vehicle interior, the opaque cover layer is behind the reflection layer such that in the region of the reflection layer, transmittance of light from the surroundings into the interior of the vehicle is avoided. As a result, the image situated in the region of the reflection layer has good contrast. The inventors have found that a reflection layer comprising a metal carbide-based layer is particularly suitable in terms of a smooth and intense reflection spectrum for p-polarized light in the visible range of the light spectrum. By comparison, both a single low-refractive-index layer or a single high-refractive-index layer and also a combination of a low-refractive-index layer with a high-refractive-index layer have significantly more inhomogeneous reflectivity. The reflection layer according to the invention comprising a metal carbide-based layer achieves similarly high reflectivity for p-polarized light with, at the same time, a smoother reflection spectrum. The combination of the reflection layer according to the invention with the opaque cover layer, seen as behind it by a vehicle occupant, results in good visibility of the image, even with external sunlight, with vehicle occupants wearing sunglasses, and with the use of low-light light sources. Even under these circumstances, the image produced by the light source appears bright and is excellently recognizable. This enables a reduction in the power of the light source and thus in reduced energy consumption. Furthermore, metal carbide-based layers have high hardness and high chemical resistance such that the reflection coating has good resistance to mechanical damage as well as external environmental influences. This is advantageous in terms of resistance during the production process of the pane and also, depending on the arrangement of the reflection layer, in the installed position.

Preferably, the reflection layer is arranged on the interior-side surface of the inner pane such that it forms an exposed surface of the composite pane, i.e., the surface of the composite pane immediately adjacent the surroundings. In other words, the reflection layer forms the layer the farthest from the thermoplastic intermediate layer in the direction toward the inner pane. This is advantageous for achieving a particularly intense reflection spectrum. Due to their high mechanical and chemical resistance, reflection layers with metal carbide-based layers enable a long service life of the reflection layer even when used on exposed surfaces.

From the perspective of a vehicle occupant, the reflection layer is arranged spatially in front of the opaque cover layer when viewed through the inner pane. As a result, the region of the composite pane in which the reflection layer is arranged appears opaque. The reflection layer in front of the opaque background is preferably transparent, but can itself even be opaque. The expression “when viewed through the composite pane” means looking through the composite pane, starting from the interior-side surface of the inner pane. In the context of the present invention, “spatially in front of” means that the reflection layer is arranged spatially farther from the exterior-side surface of the outer pane than at least the opaque cover layer. The opaque cover layer can be applied to one or more pane surfaces. In this regard, one advantage of the invention is that the reflection layer is suitable to be applied freely exposed on the interior-side surface of the inner pane. Thus, the surface on which the opaque cover layer is to be placed can be freely selected according to customer wishes. In contrast, a reflection layer applied on the exterior-side surface of the inner pane or the interior-side surface of the outer pane could be covered by a masking print located further in the direction of the vehicle interior. When the opaque cover layer is arranged on the interior-side surface of the inner pane, the reflection layer is applied on the surface of the opaque cover layer facing away from the inner pane and is thus not negatively impacted in its function by the cover layer. The reflection layer can be applied indirectly or directly, preferably directly, on the opaque cover layer. Preferably, the opaque cover layer is widened at least in the region that overlaps with the reflection layer and in which the composite pane is used to display images. This means that the opaque cover layer, viewed perpendicularly to the nearest section of the circumferential edge of the composite pane, has a greater width than in other sections. In this way, the opaque cover layer can be adapted to the dimensions of the reflection layer. The opaque cover layer is preferably formed circumferentially in the edge region of the composite pane along the peripheral edge of the composite pane, with the width of the cover layer varying.

In the context of the invention, an “exposed surface” means a surface that is accessible and has direct contact with the surrounding atmosphere. It can also be referred to as an “external surface”. An exposed surface must be distinguished from internal surfaces of a composite pane that are joined to one another via the thermoplastic intermediate layer. If the pane is implemented as a composite pane, the exterior-side surface of the outer pane and the interior-side surface of the inner pane (i.e., of the substrate according to the invention) are exposed.

“Arranged flat one above another” means that the projection of a first layer into the plane of a second layer is at least partially congruent with the second layer.

When a layer is based on a material, the layer consists for the most part of this material, in particular substantially of this material in addition to any impurities or dopants, for example, dopants with aluminum, zirconium, titanium, hafnium, or boron.

The metal carbide-based layer consists for the most part of one or more metal carbides, preferably of one metal carbide for the most part. Metal carbides have good electrical conductivity and high mechanical and chemical stability. Transition metal carbides have proved particularly suitable.

The inventors have found that alloys of the metal carbide-based layer with aluminum, silicon, and/or transition metals, preferably titanium, zirconium, and/or hafnium, are advantageous for further increasing the mechanical and chemical stability of the reflection layer. Preferably, the metal carbide-based layer is alloyed with at most 49%, particularly preferably with at most 30%, in particular with at most 20% of one or more of the materials mentioned. Depending on the selection of material and the proportion of the alloy components, the electrical conductivity of the metal carbide-based layer can, however, be degraded. In practice, there is a trade-off between the desired stability and conductivity, wherein the position of the reflection layer on an exposed or nonexposed surface is taken into consideration with regard to the necessary stability.

Preferably, the electrical sheet resistance of the metal carbide-based layer is between 20 μΩ·cm and 200 μΩ·cm, particularly preferably between 50μΩ·cm and 100μΩ·cm, in particular between 50 μΩ·cm and 80 μΩ·cm, and the Vickers hardness, measured according to DIN EN ISO 6507 Part 1-4, is between 10 GPa and 40 GaPa. Metal carbide-based layers with these conductivities and hardnesses have particularly high reflectivity for p-polarized light and very good mechanical stability.

Preferably, the composite pane is a vehicle windshield.

In the context of the invention, the at least one opaque cover layer is a layer that prevents through-vision through the composite pane. Transmittance of at most 5%, preferably of at most 2%, particularly preferably of at most 1%, in particular of at most 0.1%, of the light of the visible spectrum occurs through the opaque cover layer.

The light source of the projection assembly emits p-polarized light and is arranged in the vicinity of the interior-side surface of the inner pane such that the light source irradiates this surface, with the light being reflected by the reflection layer of the composite pane. Preferably, the reflection layer reflects at least 5%, preferably at least 6%, particularly preferably at least 10% of the p-polarized light incident on the reflection layer in a wavelength range from 450 nm to 650 nm and incidence angles of 55° to 75°. This is advantageous in order to achieve the greatest possible brightness of an image emitted by the light source and reflected by the reflection layer.

The light source is used to emit an image, i.e., it can also be referred to as a display device or an image display device. A projector, a display, or even another device known to the person skilled in the art can be used as a light source. Preferably, the light source is a display, particularly preferably an LCD display, LED display, OLED display, or electroluminescent display, in particular an LCD display. Displays have a low installation height and can thus be easily and space-savingly integrated into the dashboard of a vehicle. In addition, compared to projectors, displays are significantly more energy-efficient to operate. The comparatively lower brightness of displays is completely sufficient in combination with the reflection layer according to the invention and the opaque cover layer positioned behind it. The radiation of the light source preferably strikes the composite pane at an angle of incidence of 55° to 80°, preferably 62° to 77°, in the region of reflection layer. The angle of incidence is the angle between the incidence vector of the radiation from the image display device and the surface normal in the geometric center of the reflection layer.

The term “p-polarized light” means light of the visible spectrum that predominantly has p-polarization. The p-polarized light preferably has a light proportion with p-polarization of at least 50%, preferably of at least 70%, particularly preferably of at least 90%, and in particular of roughly 100%. The consideration of the polarization direction is based on the plane of incidence of the radiation on the composite pane. “P-polarized radiation” refers to radiation whose electric field oscillates in the plane of incidence. “S-polarized radiation” refers to radiation whose electric field oscillates perpendicular to the plane of incidence. The plane of incidence is generated by the vector of incidence and the surface normal of the composite pane in the geometric center of the irradiated region. In other words, the polarization, i.e., in particular the proportion of p- and s-polarized radiation, is determined at one point of the region irradiated by the light source, preferably in the geometric center of the irradiated region. Since composite panes can be curved (for example, when they are windshields) thus affecting the plane of incidence of the radiation, slightly deviating polarization proportions can occur in the remaining regions, which is unavoidable for physical reasons.

Preferably, the projection of the first subregion, in which the reflection layer is applied, lies in the plane of the second subregion, in which the cover layer is arranged, entirely within the second subregion. In other words, the reflection layer is preferably applied exclusively in the region of the masking print and does not project beyond it. This is advantageous in order to limit the reflection layer only to the regions in which it serves to project an image and, at the same time, to keep the through-vision region of the windshield free of the reflection layer. This way, the reflection layer can have lower light transmittance than is necessary in the field of vision of the windshield according to legal requirements.

Preferably, at least one opaque cover layer is arranged in an edge region of the outer pane. Such a cover layer preferably serves to mask gluing of the composite pane, for example, as a windshield in a vehicle body. A harmonious overall impression of the composite pane in the installed state is thus achieved. Furthermore, the opaque masking print serves as UV protection for the adhesive material used.

An opaque cover layer situated on the outer pane or the inner pane is preferably screen-printed. Screen printing methods for applying opaque cover layers on panes are known per se. Such printed cover layers are also referred to as screen print or black print and contain an opaque pigment, for example, a black pigment. Known black pigments include, for example, carbon black, aniline black, bone black, iron oxide black, spinel black, and graphite. An opaque cover layer printed by screen printing is preferably subjected to a temperature treatment to permanently bond it to the glass surface. The temperature treatment is typically carried out at temperatures in the range from 450° C. to 700° C. If the outer pane is curved, the temperature treatment of a screen print to be applied thereon can also be carried out during the bending of the pane.

An opaque cover layer on the outer pane can be applied on the interior-side surface of the outer pane and/or on the exterior-side surface of the outer pane. The interior-side surface of the outer pane is preferred in that the opaque masking print is protected against weathering. Particularly preferably, at least one opaque cover layer in the form of an opaque masking print is arranged on the interior-side surface of the outer pane and/or the exterior-side surface of the inner pane. An opaque cover print applied on the exterior-side surface of the inner pane also conceals the view from the vehicle interior through the composite pane to the outside. For example, components laminated into the composite pane, such as electrical connections can be concealed. Customers also wish to be able to freely select the position of the masking print and, if need be, to also be able to apply it on the interior-side surface or the exterior-side surface of the inner pane. In contrast to layers that are suitable only for use on the inside of the composite pane, the reflection layer arranged on the interior-side surface of the inner pane directly adjacent the surroundings enables a combination with cover layers on any surfaces of the inner pane.

The reflection layer is preferably applied on a subregion of the interior-side surface of the inner pane. The reflection layer is preferably in direct contact with the interior-side surface of the inner pane (side IV) or, alternatively, an opaque cover layer applied on this surface. The reflection layer is arranged at least in one region on the side IV of the composite pane that is in overlap with the opaque cover layer when viewed through the composite pane. This means that the p-polarized light that is projected from the light source onto the reflection layer strikes the composite pane in the region in which the opaque cover layer is positioned. As a result, high contrast of the display is achieved.

The metal carbide-based layer preferably contains at least 95 wt.-% of one or more metal carbides, particularly preferably at least 97 wt.-% one or more metal carbides. This results in good electrical conductivity, which is associated with good reflection properties for p-polarized light. Preferably, the metal carbide-based layer contains at least 95 wt.-% of a metal carbide. Particularly preferably, the metal carbide-based layer contains chromium carbide, titanium carbide, zirconium carbide, hafnium carbide, molybdenum carbide, and/or tungsten carbide, in particular, chromium carbide or titanium carbide. Chromium carbide and titanium carbide have proved to be particularly advantageous in terms of their good availability, high hardness, durability, and conductivity and easy deposition. In a particularly preferred, the metal carbide-based layer consists substantially of one of the metal carbides mentioned, in particular chromium carbide or titanium carbide, in addition to any impurities.

In another particularly preferred embodiment, the metal carbide-based layer consists of chromium carbide, titanium carbide, zirconium carbide, hafnium carbide, molybdenum carbide, and/or tungsten carbide, in particular chromium carbide or titanium carbide and 2% to 30% titanium, zirconium, and/or hafnium.

The metal carbide-based layer preferably has a thickness of 10 nm to 100 nm, particularly preferably 15 nm to 70 nm, in particular 20 nm to 50 nm. In these ranges, it was possible to achieve particularly good reflection and mechanical properties, with the layer being thin enough to be deposited economically.

In a preferred embodiment, the reflection layer consists of a single metal carbide-based layer and includes no other layers. This is advantageous for providing an economical reflection layer that is simple to manufacture. If the reflection layer is intended to be applied on the exterior-side surface of the inner pane, it preferably consists of a single metal carbide-based layer. However, also with regard to reflection layers that are applied on the interior-side surface of the inner pane, the high mechanical stability of the metal carbide-based layer is crucial in making such embodiments possible.

In the context of the invention, if a first layer is arranged “above” a second layer, this means that the first layer is arranged farther from the substrate on which the coating is applied than the second layer. In the context of the invention, if a first layer is arranged “below” a second layer, this means that the second layer is arranged farther from the substrate than the first layer. With regard to the reflection layer, the inner pane serves as a substrate, with the reflection layer applied on the interior-side surface of the inner pane. Thus, a second layer placed above the metal carbide-based layer is farther from the interior-side surface of the inner pane than the metal carbide-based layer.

In another preferred embodiment, the reflection layer comprises at least one metal carbide-based layer and one dielectric layer, with the dielectric layer placed above the metal carbide-based layer. Preferably, such a reflection layer is provided on the interior-side surface of the inner pane. This results in a layer stack comprising, starting from the interior-side surface of the inner pane, in this order, arranged flat one above another, at least one metal carbide-based layer and one dielectric layer. A dielectric layer above the metal carbide-based layer is advantageous for protecting the metal carbide-based layer against mechanical stress. Furthermore, the dielectric layer acts as a barrier layer that also further increases the chemical resistance of the metal carbide-based layer. Particularly preferably, the reflection coating includes exactly one dielectric layer.

The at least one dielectric layer is preferably implemented as an optically low-refractive-index layer with a refractive index less than 1.6, preferably at most 1.5, particularly preferably at most 1.45, for example 1.25 to 1.35. These values have proved to be particularly advantageous in terms of the reflection properties of the pane.

In the context of the present invention, refractive indices are in principle indicated based on a wavelength of 550 nm. Methods for determining refractive indices are known to the person skilled in the art. The refractive indices indicated in the context of the invention can be determined, for example, by means of ellipsometry, using commercially available ellipsometers. The indications of layer thicknesses or thicknesses are based, unless otherwise indicated, on the geometric thickness of a layer.

The low-refractive-index layer is preferably based on silicon oxide. If a layer of silicon oxide is placed above the metal carbide-based layer, a further substantial improvement of the total reflection of the reflection layer can be observed. The reflection properties of the layer are determined, on the one hand, by the refractive index and, on the other, by the thickness of the low-refractive-index layer. The reflection properties of the layer are determined, on the one hand, by the refractive index and, on the other, by the thickness of the low-refractive-index layer. In a preferred embodiment, the refractive index of the low-refractive-index layer is from 1.2 to 1.4, particularly preferably from 1.25 to 1.35. A refractive index in these ranges is particularly advantageous for achieving a homogeneous reflection spectrum in the range of incidence angles around 65° and around 75°. The thickness of the low-refractive-index layer is preferably from 50 nm to 200 nm, particularly preferably from 100 nm to 150 nm. Good reflection properties are achieved therewith.

When a layer is based on a material, the layer consists for the most part of this material, in particular substantially of this material, in addition to any impurities or dopants. The oxides and nitrides mentioned can be deposited stoichiometrically, substoichiometrically, or superstoichiometrically (even when a stoichiometric chemical formula is indicated). They can have dopants, for example, aluminum, zirconium, hafnium, titanium, or boron.

The silicon oxide can be doped, for example, with aluminum, zirconium, titanium, boron, tin, or zinc. In particular, the optical, mechanical, and chemical properties of the coating can be adapted by dopants.

The low-refractive-index layer preferably comprises only one homogeneous layer of silicon oxide. However, it is also possible to form the low-refractive-index layer from multiple layers of silicon oxide. For example, multiple layers of nanoporous silicon oxide that differ from one another in terms of porosity (size and/or density of the pores) can be deposited. In this way, a progression of refractive indices can be generated, as it were.

The optically low-refractive-index layer is preferably applied by physical or chemical vapor deposition, i.e., a PVD or CVD method (PVD: physical vapor deposition, CVD: chemical vapor deposition). Particularly preferably, the low-refractive-index layer is a coating applied by cathodic sputtering (“sputtered-on”), in particular a coating applied by magnetron-enhanced cathodic sputtering (“magnetron-sputtered”). This has the advantage that both the metal carbide-based layer and the low-refractive-index layer can be deposited using the same method.

In another possible embodiment, the low-refractive-index layer is a sol-gel coating. Advantages of the sol-gel method as a wet chemical method are high flexibility, which allows, for example, in a simple manner, providing only parts of the pane surface with the coating, and low costs compared to vapor deposition methods such as cathodic sputtering.

In the sol-gel method, first, a sol containing the precursors of the coating is provided and ripened. The ripening can involve hydrolysis of the precursors and/or a (partial) reaction between the precursors. The precursors are usually present in a solvent, preferably water, alcohol (in particular, ethanol), or a water-alcohol mixture.

In a possible embodiment, the low-refractive-index layer is deposited on the metal carbide-based layer using a sol-gel process. First, a sol containing the precursors of the coating is provided and ripened. The ripening can involve hydrolysis of the precursors and/or a (partial) reaction between the precursors. This sol is referred to in the context of the invention as a precursor sol and contains silicon oxide precursors in a solvent. The precursors are preferably silanes, in particular tetraethoxy silanes or methyl triethoxysilane (MTEOS). However, alternatively, silicates can also be used as precursors, in particular sodium, lithium, or potassium silicates, for example, tetramethyl orthosilicate, tetraethyl orthosilicate (TEOS), tetraisopropyl orthosilicate, or organo-silanes of the general form R²ₙSi(OR¹)₄₋ₙ. Here, preferably, R¹ is an alkyl group; R² is an alkyl, epoxy, acrylate, methacrylate, amine, phenyl, or vinyl group; and n is an integer from 0 to 2. Silicon halides or alkoxides can also be used. The solvent is preferably water, alcohol (in particular ethanol), or a water-alcohol mixture.

The precursor sol is then mixed with a pore former dispersed in an aqueous phase. The purpose of the pore former is to create the pores in the silicon oxide matrix, so to speak, as a placeholder in the creation of the low-refractive-index layer. The shape, size, and density of the pores is determined by the shape, size, and concentration of the pore former. The pore size, pore distribution, and pore density can be selectively controlled by the pore former and reproducible results are ensured. Polymer nanoparticles can, for example, be used as pore formers, preferably PMMA nanoparticles (polymethyl methacrylate), but also, alternatively, nanoparticles of polycarbonates, polyesters, or polystyrenes, or copolymers of methyl(meth)acrylates and (meth)acrylic acid. Instead of polymer nanoparticles, nanodroplets of an oil in the form of a nano-emulsion can also be used. Of course, it is also conceivable to use different pore formers.

The sol is applied to the interior-side surface of the inner pane directly or indirectly, in particular by wet chemical methods, for example, by dip coating, spin coating, flow coating, by application using rollers or brushes or by spray coating, or by printing methods, for example, by pad printing or screen printing. This can be followed by drying, with the solvent being evaporated. This drying can be carried out at ambient temperature or by separate heating (for example, at a temperature of up to 120° C.). Before applying the layer to the substrate, the surface is typically cleaned by methods known per se.

Then, the sol is condensed. During this process, the silicon oxide matrix forms around the pore former. The condensation can include a temperature treatment, for example, at a temperature of, for example, up to 350° C. if the precursors have UV cross-linkable functional groups (for example, methacrylate, vinyl, or acrylate groups), the condensation can include a UV treatment. Alternatively, for suitable precursors (for example, silicates), the condensation can include an IR treatment. Optionally, solvent can be evaporated at a temperature of up to 120° C.

Then, the pore former is optionally removed. For this purpose, the coated substrate is preferably subjected to a heat treatment at a temperature of at least 400° C., preferably at least 500° C., wherein the pore formers decompose. Organic pore formers are carbonized. The heat treatment can be carried out as part of a bending process or a thermal tempering process. The heat treatment is preferably carried out over a period of at most 15 min, particularly preferably at most 5 min. In addition to removing the pore formers, the heat treatment can also be used to complete the condensation and thus to densify the coating, which improves its mechanical properties, in particular its stability.

Instead of using the heat treatment, the pore former can also be dissolved out of the coating by solvents. In the case of polymer nanoparticles, the corresponding polymer must be soluble in the solvent, for example, in the case of PMMA nanoparticles, tetrahydrofuran (THF) can be used.

Removal of the pore former is preferred, creating empty pores. In principle, however, it is also possible to leave the pore former in the pores. If it has a different refractive index from the silicon oxide, this is affected thereby. The pores are then filled with the pore former, for example, with PMMA nanoparticles. Hollow particles can also be used as pore formers, for example, hollow polymer nanoparticles such as PMMA nanoparticles or hollow silicon oxide nanoparticles. If such a pore former is left in the pores and not removed, the pores have a hollow core and an edge region filled with the pore former.

The sol-gel method described enables production of a low-refractive-index layer with a regular, homogeneous distribution of pores. The pore shape, size, and density can be selectively adjusted, and the low-refractive-index layer has low tortuosity.

Optionally, a reflection coating applied on the interior-side surface of the inner pane includes an organic protective layer, which faces the vehicle interior in the installed state of the projection assembly in a vehicle. The organic protective layer does not contribute or contributes only insignificantly to the optical characteristics of the reflection coating, but protects the underlying layers of the reflection coating against contamination. Preferably, the organic protective layer is a hydrophobic coating. Suitable hydrophobic coatings are commercially available, for example, fluoro-organic compounds as DE19848591 also describes. Known hydrophobic coatings are, for example, products based on perfluoropolyethers or fluorosilanes. These are, for example, layers applied in liquid form, for example, by spraying, dipping, and flowing or by application using a cloth. Alternatively, hydrophobic films are available as nanolayer systems, which are applied, for example, by chemical or physical vapor deposition.

Preferably, the dielectric layer is deposited directly on the metal carbide-based layer, i.e., there are no further layers arranged between the metal carbide-based layer and the dielectric layer.

In a particularly preferred embodiment, the reflection layer consists of exactly one metal carbide-based layer. In another particularly preferred embodiment, the reflection layer consists of a metal carbide-based layer and an organic protective layer applied above the metal carbide-based layer. In another particularly preferred embodiment, the reflection layer consists of a layer stack of, in the following order starting from the interior-side surface of the inner pane, a metal carbide-based layer, a dielectric layer, and an organic protective layer.

Particularly preferably, the reflection coating consists of exactly one single metal carbide-based layer, exactly one single dielectric layer, optionally, an organic protective layer, and has no other layers below or above these layers. The inventors have found that such a reflection coating has a homogeneous reflection spectrum for p-polarized light.

In order to achieve the most color-neutral display possible of the image produced in the region of the reflection layer, the reflection spectrum for p-polarized radiation should be as smooth as possible and should have no pronounced local minima and maxima. In the spectral range from 450 nm to 650 nm, the difference between the maximally occurring reflectance and the mean of the reflectance as well as the difference between the minimally occurring reflectance and the mean of the reflectance in a preferred embodiment should be at most 3%, particularly preferably at most 2%. The resultant difference is to be considered as the absolute deviation of reflectance (reported in %), not as a percentage deviation relative to the mean. Alternatively, the standard deviation in the spectral range from 450 nm to 650 nm can be used as a measure of the smoothness of the reflection spectrum. In this regard, a reflection layer comprising exactly one metal carbide-based layer and exactly one dielectric layer has proved to be advantageous, whereby with increasing conductivity of the metal carbide-based layer, improved smoothness of the reflection spectrum is achieved.

In a preferred embodiment of the invention, an HUD layer is arranged between the interior-side surface of the outer pane and the exterior-side surface of the inner pane. The principle of a head-up display (HUD) and the technical terms used here from the field of HUDs are generally known to the person skilled in the art. For a detailed presentation, reference is made to Alexander Neumann's dissertation “Simulation-Based Measurement Technology for Testing Head-Up Displays” at the Institute of Computer Science at the Technical University of Munich (Munich: University Library of the Technical University of Munich, 2012), in particular Chapter 2 “The Head-Up Display”. The HUD layer is arranged between the outer pane and the inner pane, where “between” can mean both within the thermoplastic intermediate layer and also in direct spatial contact on the inner side of the outer pane and on the outer side of the inner pane. The HUD layer is suitably designed to reflect p-polarized light. The HUD layer is a reflection coating that is incorporated into the composite pane over a large area, with the region in which the HUD coating is situated also referred to as the HUD region. To use the composite pane as a head-up display, a projector is directed at the HUD region of the composite pane. The radiation of the projector is preferably predominantly p-polarized. The HUD layer is suitable for reflecting p-polarized radiation. As a result, a virtual image that the driver of a vehicle can perceive from his perspective as behind the composite pane is produced from the projector radiation.

The projection assembly according to the invention is particularly suitable for combination with an HUD layer. The reflection layer provided on the interior-side surface of the inner pane and the opaque cover layer applied in this region are only limited locally to the edge region of the composite pane and thus do not affect the HUD layer applied in the through-vision region of the composite pane. Because of the fact that the reflection layer is positioned on an exposed surface of the composite pane, the HUD layer can be applied independently thereof on one of the internal surfaces of the composite pane and is protected there against environmental influences.

The HUD layer preferably includes at least one metal selected from the group consisting of aluminum, tin, titanium, copper, chromium, cobalt, iron, manganese, zirconium, cerium, yttrium, silver, gold, platinum, and palladium, or mixtures thereof.

In a preferred embodiment of the invention, the HUD layer is a coating containing a thin-layer stack, i.e., a layer sequence of thin individual layers. This thin-layer stack contains one or more electrically conductive layers based on silver. The electrically conductive layer based on silver gives the reflection coating the basic reflecting properties and also an IR-reflecting effect and electrical conductivity. The electrically conductive layer is based on silver. The conductive layer preferably contains at least 90 wt.-% silver, particularly preferably at least 99 wt.-% silver, most particularly preferably at least 99.9 wt.-% silver. The silver layer can have dopants, for example, palladium, gold, copper, or aluminum. Materials based on silver are particularly suitable for reflecting p-polarized light. The use of silver has proved to be particularly advantageous in the reflection of p-polarized light. The coating has a thickness of 5 nm to 50 nm and preferably of 8 nm to 25 nm.

If the HUD layer is implemented as a coating, it is preferably applied on the inner pane or the outer pane by physical vapor deposition (PVD), particularly preferably by cathodic sputtering (“sputtering”), and most particularly preferably magnetron-enhanced cathodic sputtering (“magnetron sputtering”). However, in principle, the coating can also be applied, for example, using chemical vapor deposition (CVD), for example, plasma-enhanced vapor deposition (PECVD), by vapor deposition, or by atomic layer deposition (ALD). The coating is applied to the panes prior to lamination.

The HUD layer can also be implemented as a reflecting film that reflects p-polarized light. The HUD layer can be a carrier film with a reflecting coating or a reflecting polymer film. The reflecting coating preferably comprises at least one layer based on a metal and/or a dielectric layer sequence with alternating refractive indices. The layer based on a metal preferably contains or consists of silver and/or aluminum. The dielectric layers can, for example, be based on silicon nitride, zinc oxide, tin-zinc oxide, mixed silicon-metal nitrides, such as silicon-zirconium nitride, zirconium oxide, niobium oxide, hafnium oxide, tantalum oxide, or silicon carbide. The oxides and nitrides mentioned can be deposited stoichiometrically, substoichiometrically, or superstoichiometrically. They can have dopants, for example, aluminum, zirconium, titanium, or boron. The reflecting polymer film preferably comprises or consists of dielectric polymer layers. The dielectric polymer layers preferably contain PET. If the HUD layer is implemented as a reflecting film, it is preferably from 30 μm to 300 μm thick, particularly preferably from 50 μm to 200 μm, and in particular from 100 μm to 150 μm.

If it is a coated reflecting film, the CVD or PVD coating methods can also be used for production.

According to another preferred embodiment, the HUD layer is implemented as a reflecting film and is arranged within the thermoplastic intermediate layer. The advantage of this arrangement is that the HUD layer does not have to be applied on the outer pane or the inner pane by means of thin-film technology (for example, CVD and PVD). This results in uses of the HUD layer with further advantageous functions such as a more homogeneous reflection of the p-polarized light on the HUD layer. In addition, the production of the composite pane can be simplified since the HUD layer does not have to be arranged on the outer or the inner pane via an additional process prior to lamination.

The composite pane of the projection assembly is preferably a windshield. The optionally present HUD layer is positioned within the through-vision region of the composite pane. The total transmittance through the composite pane is, in an embodiment as a windshield of a motor vehicle, at least 70%, based on illuminant A. The term “total transmittance” is based on the process for testing the light permeability of motor vehicle windows specified by ECE-R 43, Annex 3, § 9.1.

The outer pane and the inner pane preferably contain or consist of glass, particularly preferably flat glass, float glass, quartz glass, borosilicate glass, soda lime glass, aluminosilicate glass, or clear plastics, preferably rigid clear plastics, in particular polyethylene, polypropylene, polycarbonate, polymethyl methacrylate, polystyrene, polyamide, polyester, polyvinyl chloride, and/or mixtures thereof.

The outer pane and the inner pane can have further suitable coatings known per se, for example, antireflection coatings, nonstick coatings, scratch resistant coatings, photocatalytic coatings, or sun-shading coatings or low-E coatings.

The thickness of the individual panes (outer pane and inner pane) can vary widely and can be adapted to the requirements of the individual case. Preferably, panes with the standard thicknesses of 0.5 mm to 5 mm and preferably of 1.0 mm to 2.5 mm are used. The size of the panes can vary widely and is governed by the use.

The composite pane can have any three-dimensional shape. Preferably, the outer pane and the inner pane have no shadow zones such that they can, for example, be coated by cathodic sputtering. Preferably, the outer pane and the inner pane are flat or slightly or strongly curved in one or more spatial directions.

The thermoplastic intermediate layer contains or is made of at least one thermoplastic, preferably butyral (PVB), ethylene vinylacetate (EVA), and/or polyurethane (PU) or copolymers or derivatives thereof, optionally, in combination with polyethylene terephthalate (PET). However, the thermoplastic intermediate layer can also contain, for example, polypropylene (PP), polyacrylate, polyethylene (PE), polycarbonate (PC), polymethyl methacrylate, polyvinyl chlorid, polyacetate resin, casting resin, acrylate, fluorinated ethylene-propylene, polyvinyl fluoride, and/or ethylene tetrafluoroethylene, or a copolymer or mixture thereof.

The thermoplastic intermediate layer is preferably implemented as at least one thermoplastic composite film and contains or is made of polyvinyl butyral (PVB), particularly preferably of polyvinyl butyral (PVB) and additives known to the person skilled in the art, such as plasticizers. Preferably, the thermoplastic intermediate layer contains at least one plasticizer.

Plasticizers are chemical compounds that make plastics softer, more flexible, smoother, and/or more elastic. They shift the thermoelastic range of plastics to lower temperatures such that the plastics have the desired more elastic properties in the range of the temperature of use. Preferred plasticizers are carboxylic acid esters, in particular low-volatility carboxylic acid esters, fats, oils, soft resins, and camphor. Other plasticizers are preferably aliphatic diesters of tri- or tetraethylene glycols. Particularly preferably used as plasticizers are 3G7, 3G8, or 4G7, where the first digit indicates the number of ethylene glycol units and the last digit indicates the number of carbon atoms in the carboxylic acid portion of the compound. Thus, 3G8 represents triethylene glycol-bis-(2-ethyl hexanoate), in other words, a compound of the formula C₄H₉CH(CH₂CH₃)CO(OCH₂CH₂)₃O₂CCH(CH₂CH₃)C₄H₉.

Preferably, the thermoplastic intermediate layer based on PVB contains at least 3 wt.-%, preferably at least 5 wt.-%, particularly preferably at least 20 wt.-%, even more preferably at least 30 wt.-% and in particular at least 35 wt.-% of a plasticizer. The plasticizer contains or is made, for example, of triethylene glycol-bis-(2-ethyl hexanoate).

The thermoplastic intermediate layer can be formed by a single film or, also, by more than one film. The thermoplastic intermediate layer can be formed by one or more thermoplastic films arranged one above another, with the thickness of the thermoplastic intermediate layer preferably being from 0.25 mm to 1 mm, typically 0.38 mm or 0.76 mm.

The thermoplastic intermediate layer can also be a functional thermoplastic intermediate layer, in particular an intermediate layer with acoustically damping properties, an infrared-radiation-reflecting intermediate layer, an infrared-radiation-absorbing intermediate layer, and/or a UV-radiation-absorbing intermediate layer. For example, the thermoplastic intermediate layer can also be a band filter film that blocks out narrow bands of visible light.

The invention further includes a method for producing a projection assembly according to the invention. The method includes at least the steps:
(a) Providing an outer pane, an inner pane, and a thermoplastic intermediate layer,
(b) Applying at least one opaque cover layer in at least one second subregion of the exterior-side surface of the outer pane, the interior-side surface of the outer pane, the exterior-side surface of the inner pane, and/or on the exterior-side surface of the inner pane,
(c) Combining the inner pane, the thermoplastic intermediate layer, and the outer pane in this order to form a layer stack,
(d) Laminating the layer stack to form a composite pane,
(e) Applying a reflection layer to at least one first subregion of the interior-side surface of the inner pane and/or the exterior-side surface of the inner pane, with the first subregion running at least partially overlapping the second subregion and with the applied reflection layer positioned toward the interior relative to the opaque cover layer,
(f) Aiming a light source for p-polarized light toward the composite pane such that the p-polarized light can strike the reflection layer.

Step e) of the method can be carried out either before, during, or after the steps a) through d). However, if at least one opaque cover layer is applied on the interior-side surface of the inner pane, the reflection layer is not applied until after this opaque cover layer has been applied.

Preferably, the reflection layer is applied on the interior-side surface of the inner pane as a layer exposed to the surroundings.

The reflection layer reflects the p-polarized light. The p-polarized light leaves the composite pane on the inner side of the inner pane.

The layer stack is laminated under the action of heat, vacuum, and/or pressure, with the individual layers joined to one another (laminated) by at least one thermoplastic intermediate layer. Methods known per se can be used to produce a composite pane. For example, so-called autoclave methods can be carried out at an elevated pressure of approx. 10 bar to 15 bar and temperatures from 130° C. to 145° C. for roughly 2 hours. Vacuum bag or vacuum ring methods known per se operate, for example, at roughly 200 mbar and 130° C. to 145° C. The outer pane, the inner pane, and the thermoplastic intermediate layer can also be pressed in a calendar between at least one pair of rollers to form a composite pane. Facilities of this type for producing composite panes are known and normally have at least one heating tunnel upstream from a press. The temperature during the pressing operation is, for example, from 40° C. to 150° C. Combinations of calendering and autoclave methods have proved particularly useful in practice. Alternatively, vacuum laminators can be used. These consist of one or more heatable and evacuable chambers in which the outer pane and the inner pane can be laminated within, for example, about 60 minutes at reduced pressures from 0.01 mbar to 800 mbar and temperatures from 80° C. to 170° C.

Methods for applying the reflection layer and the structure of the reflection layer have already been discussed in the description of the reflection layer itself.

In a preferred embodiment of the method, an HUD layer is applied on the interior-side surface of the inner pane and/or the exterior-side surface of the inner pane before, during, or after one of steps a) and b). In another preferred embodiment, the HUD layer is a component of the thermoplastic intermediate layer and is introduced therewith into the composite pane. Methods for applying an HUD layer have already been discussed in the description of the projection assembly according to the invention.

The method features discussed in the description of the projection assembly according to the invention also apply to the method according to the invention.

The projection assembly according to the invention is preferably used in vehicles for travel on land, in the air, or on water, in particular in motor vehicles. Particularly preferred is the use of the composite pane as a vehicle windshield.

The various embodiments of the invention can be implemented individually or in any combinations. In particular, the features mentioned above and to be explained below can be used not only in the combinations indicated but also in other combinations or in isolation without departing from the scope of the present invention.

The invention is explained in greater detail in the following using exemplary embodiments with reference to the accompanying figures. They depict, in simplified representation, not to scale:

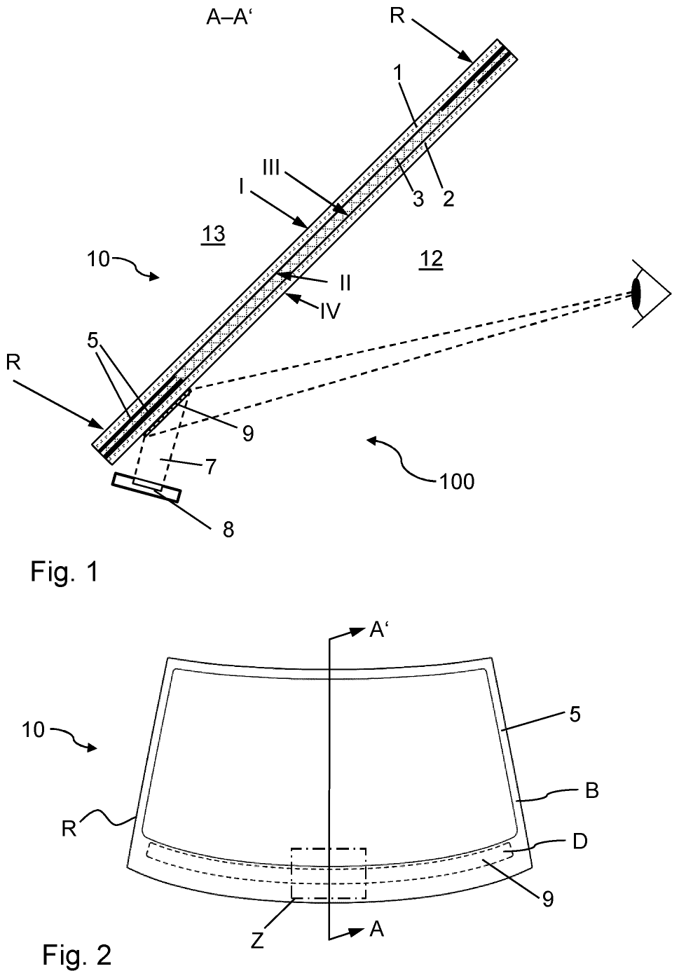

FIG. 1 a cross-sectional view of a preferred embodiment of the projection assembly according to the invention,

FIG. 2 a plan view of the composite pane of FIG. 1,

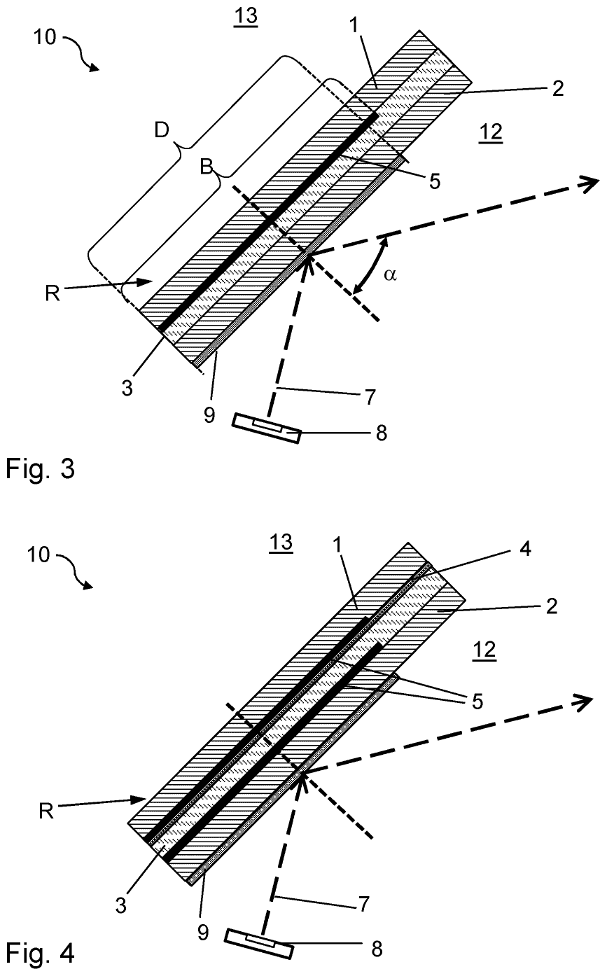

FIG. 3-4 different embodiments of the projection assembly according to the invention in the detail Z along the section line AA′ of FIG. 2,

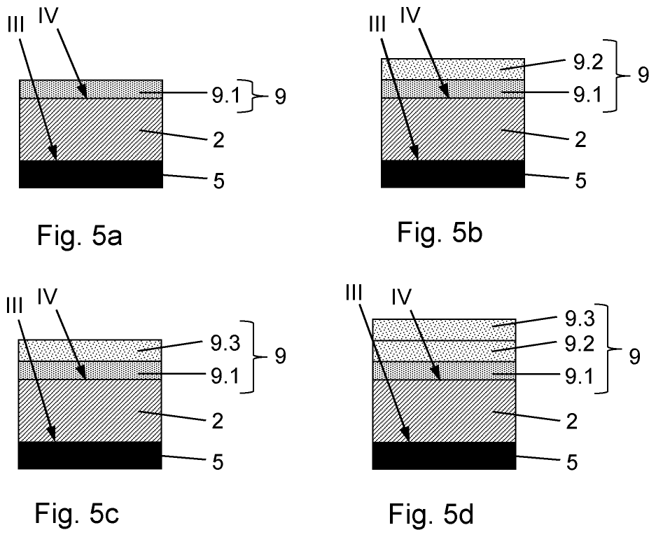

FIG. 5a-d different embodiments of the reflection coating of the projection assembly according to the invention,

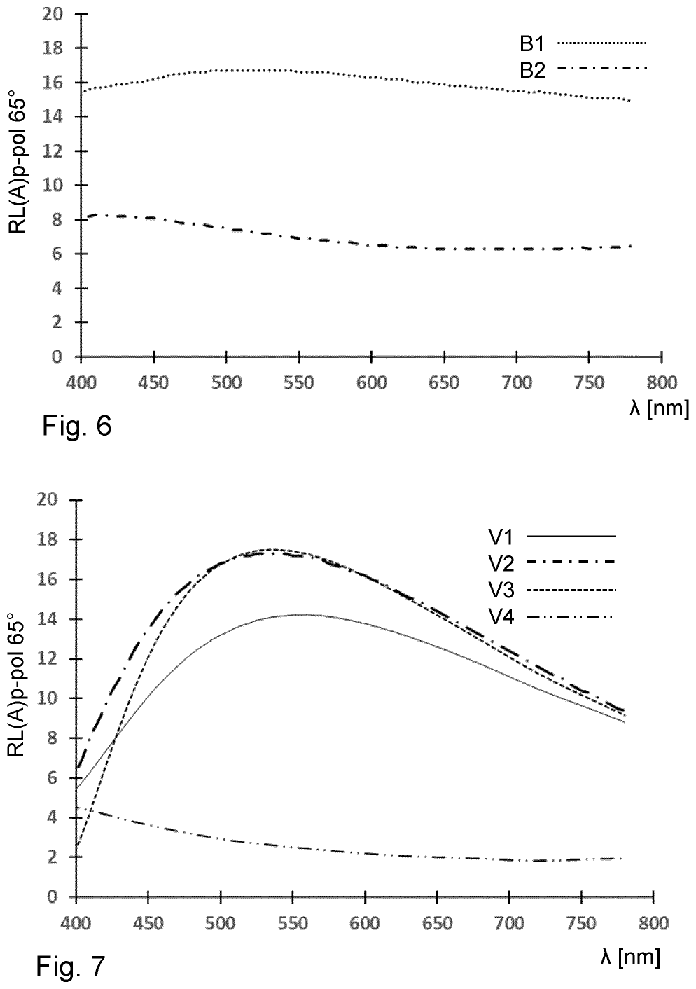

FIG. 6 reflection spectra of the composite panes according to the invention in accordance with Examples 1 and 2 of Table 1 for p-polarized radiation at 65°,

FIG. 7 reflection spectra of the composite panes according to the invention in accordance with Comparative Examples 1 through 4 of Table 2 for p-polarized radiation at 65°.

FIG. 1 schematically depicts a cross-sectional view of an exemplary embodiment of the projection assembly 100 according to the invention in the installed state in a vehicle. FIG. 2 depicts a plan view of the composite pane 10 of the projection assembly 100. The cross-sectional view of FIG. 1 corresponds to the section line A-A of the composite pane 1, as indicated in FIG. 2.

The composite pane 10 comprises an outer pane 1 and an inner pane 2 with a thermoplastic intermediate layer 3 arranged between the panes. The composite pane 10 is installed in a vehicle and separates a vehicle interior 12 from external surroundings 13. For example, the composite pane 10 is the windshield of a motor vehicle.

The outer pane 1 and the inner pane 2 are each made of glass, preferably thermally toughened soda lime glass and are transparent to visible light. The thermoplastic intermediate layer 3 comprises a thermoplastic, preferably polyvinyl butyral (PVB), ethylene vinylacetate (EVA), and/or polyethylene terephthalate (PET).

The exterior-side surface I of the outer pane 1 faces away from the thermoplastic intermediate layer 3 and is, at the same time, the outer surface of the composite pane 10. The interior-side surface II of the outer pane 1 and the exterior-side surface III of the inner pane 2 each face the intermediate layer 3. The interior-side surface IV of the inner pane 2 faces away from the thermoplastic intermediate layer 3 and is, at the same time, the inner side of the composite pane 10. It goes without saying that the composite pane 10 can have any suitable geometric shape and/or curvature. As a composite pane 10, it typically has convex curvature.

In a circumferential edge region R of the composite pane 10, there is a frame-like circumferential opaque cover layer 5 on the interior-side surface II of the outer pane 1. The cover layer 5 is opaque and prevents the viewing of structures arranged to the inside of the composite pane 10. Furthermore, in the edge region R on the exterior-side surface II of the inner pane 2, the composite pane 1 likewise has an opaque cover layer 5, formed in a frame-like circumferential manner. The opaque cover layers 5 are made of an electrically nonconductive material conventionally used for masking prints, for example, a black colored screen printing ink that is baked. The opaque cover layers 5 prevent through-vision through the composite pane 10, as a result of which, for example, an adhesive bead for gluing the composite pane 10 into the vehicle body is not visible when looking from the outside 13. At least one of the cover layers 5 is applied in a subregion B of the pane. The second of the cover layers 5 can even be dispensed with. According to FIG. 2, a subregion B extends circumferentially in the edge region R of the composite pane 10. Along an edge section of the composite pane 10, the subregion B and the opaque cover layer 5 situated therein are widened, with the widened subregion B, in the installed state of the pane as a windshield in a motor vehicle, located in the vicinity of the engine edge and the dashboard.

A reflection layer 9 is situated on the interior-side surface IV of the inner pane 2. When viewed through the composite pane 10, the reflection layer 9 is arranged in overlap with one of the opaque cover layers 5 situated on the surfaces II and III, with at least one of these opaque cover layers 5 completely overlaps the reflection layer 9, i.e., the reflection layer 9 has no section that is not in overlap with one of the cover layers 5. Here, the reflection layer 9 is arranged, for example, only in a section of the edge region R of the composite pane 10 which, in the installed state, is located adjacent the engine compartment of the motor vehicle. However, it would also be possible to arrange the reflection layer 9 in an upper (roof-side) section or in a side section of the edge region R. Furthermore, a plurality of reflection layers 9 could be provided in said sections of the edge region R. For example, the reflection layers 9 could be arranged such that a (partially) circumferential image is produced. At least one of the opaque cover layers 5 situated on the interior-side surface II of the outer pane 1 and/or the exterior-side surface III of the inner pane 2 is widened in the section in which the first subregion D with reflection layer 9 is situated. In this way, an overlap of the first subregion D with the reflection layer 9 and of the second subregion B with the opaque cover layer 5 is achieved. The term “width” means the largest dimension of an opaque cover layer 5 perpendicular to its extension. The overlap according to the invention between the reflection layer 9 and the opaque cover layer 5 does not have to be made by a cover layer 5 directly adjacent the reflection layer 9. In this sense, one of the opaque cover layers 5 according to FIG. 1 is merely optional, with the remaining opaque cover layer 5 having to fill a subregion B that is at least partially congruent with the subregion D of the reflection layer 9.

The projection assembly 100 has a light source 8 as an image generator. The light source 8 is used to generate p-polarized light 7 (image information) that is directed at the reflection layer 9 and is reflected by the reflection layer 9 as reflected light into the vehicle interior 12 where it can be perceived by a viewer, e.g., driver. The reflection layer 9 is suitably designed to reflect the p-polarized light 7 of the light source 8, i.e., an image formed by the light 7 of the light source 8. The p-polarized light 7 preferably strikes the composite pane 1 at an angle of incidence of 50° to 80°, in particular of 65° to 75°. The light source 8 is, for example, a display, in this case an LCD display. It would also be possible, for example, for the composite pane 10 to be a roof panel, side pane, or rear pane.

The plan view of FIG. 2 shows the reflection layer 9 extending along the lower section of the edge region R of the composite pane 10.

Reference is now made to FIGS. 3 and 4, wherein enlarged cross-sectional views of different embodiments of the composite pane 1 are depicted. The cross-sectional views of FIGS. 3 and 4 correspond to the section line A-A in the lower section Z of the edge region R of the composite pane 1, as indicated in FIG. 2.

The embodiment of the composite pane 10 depicted in FIG. 3, corresponds essentially to the composite pane according to the embodiment of FIG. 1. In contrast thereto, the composite pane has only one opaque cover print 5, which is applied on the interior-side surface II of the outer pane 1. The opaque cover layer 5 is situated in the subregion B. In the subregion D, the reflection layer 9 is applied on the interior-side surface IV. The image projected by the light source 8 onto the reflection layer 9 is readily recognizable with high contrast in front of the background of the opaque cover layer 5.

The embodiment of the composite pane 10 depicted in FIG. 4 differs from the embodiment of FIG. 3 in that it has two opaque cover layers 5. One opaque cover layer 5 is applied on the exterior-side surface III of the inner pane 2, while another opaque cover layer 5 is situated on the interior-side surface II. In addition, the composite pane 10 includes an HUD layer 4 applied on the interior-side surface II of the outer pane 1. The HUD layer 4 also extends into the through-vision region of the composite pane 10, i.e., the region in which none of the opaque cover layers 5 is present. A projector (not shown) can be aimed at this region of the pane and the HUD layer 4 and the HUD layer 4 can be created as a projection surface for a virtual image. The opaque cover layer 5 nearest the reflection layer 9 is applied on the exterior-side surface III of the inner pane 1 and serves there as an opaque background of the image of the reflection layer. The opaque cover layer 5 on the exterior-side surface III of the inner pane 2 conceals the HUD layer 4 for the viewer situated in the interior 12. The HUD layer 4 can be used independently of the reflection layer 9, with the image of the reflection layer 9 and the HUD image not affecting one another.

FIG. 5a-d depict different embodiments according to the invention of the reflection layer 9 that is applied on the interior-side surface IV of the inner pane 2. In all embodiments of FIG. 5a-d, an opaque cover layer 5 is applied on the exterior-side surface III of the inner pane 2. According to FIG. 5a, the reflection layer 9 consists of a metal carbide-based layer 9.1. According to FIG. 5b, the reflection layer 9 consists of, in this order, a metal carbide-based layer 9.1 and a dielectric layer 9.2 applied on the interior-side surface IV of the inner pane 2. In FIG. 5c, a reflection coating 9 consisting of, in this order, a metal carbide-based layer 9.1 and an organic protective layer 9.3 applied on the interior-side surface IV of the inner pane 2. In a further embodiment according to FIG. 5d, the reflection layer 9 consists of, in this order, starting from the interior-side surface IV of the inner pane 2, a metal carbide-based layer 9.1, a dielectric layer 9.2, and an organic protective layer 9.3.

In other embodiments according to the invention, the reflection coating 9 is implemented according to one of FIG. 5a-5d, and the opaque cover layer 5 is situated on the interior-side surface III of the outer pane 1. In all exemplary embodiments, the reflection layer 9 is arranged to the vehicle interior relative to the opaque cover layer 5, i.e., when looking toward the inner side of the composite pane 10, the reflection layer 9 is situated in front of the opaque cover layer 5.

The invention is explained in the following with reference to Examples and Comparative Examples. The reflection properties of composite panes according to the invention for p-polarized light and of composite panes not according to the invention are compared in the following. The basic structure of the composite panes corresponds to that described in FIG. 3, with the composite panes differing in the composition of the reflection layer and in the position of the reflection layer on the exterior-side surface III or the interior-side surface IV of the inner pane. The reflection layer is applied in each case on the interior-side surface IV or the exterior-side surface III of the inner pane 2 in a region D that lies within the region B in which an opaque cover print 5 is applied. The layer thicknesses, the layer structure, and the refractive indices of the dielectric layers are summarized in Table 1 for the Examples B1 and B2 according to the invention and in Table 2 for the Comparative Examples V1 through V4 not according to the invention. In the Examples B1 and B2 according to the invention, the reflection layer 9 includes a metal carbide-based layer and a dielectric layer, while in the Comparative Examples V1 through V4 not according to the invention, only dielectric layers are used.

TABLE 1

| | | | Layer Thicknesses and | |
|---|---|---|---|---|
| | Reference | | Refractive Indices | |
| | Characters | | B1 | B2 |
| Dielectric Layer | 9 | 9.2 | — | — |
| Metal Carbide-Based Layer | | 9.1 | TiC | TiC |
| | | | 45 nm | 45 nm |
| Soda Lime Glass | 2 | | | |
| Surface with Reflection Layer 9 | | | III | IV |

TABLE 2

| Dielectric | Reference | Layer Thicknesses and Refractive Indices | | | |
|---|---|---|---|---|---|
| Layers | Characters | V1 | V2 | V3 | V4 |
| TiO₂ | 9 | — | — | 50.0 nm, | — |
| | | | | n = 2.45 | |
| SiO₂ | | 190.0 nm, | — | 190.0 nm, | — |
| | | n = 1.45 | | n = 1.45 | |
| TiO₂ | | 50.0 nm, | — | 50.0 nm, | 50.0 nm, |
| | | n = 2.45 | | n = 2.45 | n = 2.45 |
| SiAlOₓ | | — | 125 nm, | — | — |
| | | | n = 1.45 | | |
| TiOₓ | | — | 60 nm, | — | — |
| | | | n = 2.45 | | |
| Soda Lime | 2 | | | | |
| Glass | | | | | |
| Surface with | | IV | IV | IV | IV |
| Reflection | | | | | |
| Layer 9 | | | | | |

The reflectivity for p-polarized light, which is essential for image quality, is referred to as RL(A) p-pol and is determined at the interior-side surface IV of the inner pane 2 at 65°. The values for reflection (RL) are based on illuminant A, which by definition is based on the relative radiation distribution of the Planckian radiator at 2856 Kelvin. The corresponding reflection spectra are shown in FIGS. 6 and 7.

A comparison of the properties of the reflection layer 9 according to Examples B1 and B2 and Comparative Examples V1 through V4 shows that the reflection layers according to the invention according to Examples B1 and B2 have comparable reflection at 65° compared to Comparative Examples V1 through V4, with the reflection layers according to Examples B1 and B2 yielding a significantly smoother reflection spectrum that the viewer perceives as a color-neutral projection image.

In initial tests by the inventors, it has been demonstrated that similarly smooth reflection spectra with good reflection intensity are achieved by means of a reflection layer consisting of a layer of chromium carbide (Cr₃C₂ with a thickness of 40 nm) as a metal carbide-based layer and a dielectric layer of SiO₂ with a refractive index of 1.45 and a thickness of 100 nm, wherein the reflection layer had been applied on the interior-side surface of the inner pane.

### LIST OF REFERENCE CHARACTERS

10 composite pane
1 outer pane
2 inner pane
3 thermoplastic intermediate layer
4 HUD layer
5 opaque cover layer
7 p-polarized light of the light source
8 light source
9 reflection layer
9.1 metal carbide-based layer
9.2 dielectric layer
9.3 organic protective layer
12 vehicle interior
13 external surroundings
100 projection assembly
D first subregion
B second subregion
R edge region
I exterior-side surface of the outer pane 1
II interior-side surface of the outer pane 1
III exterior-side surface of the inner pane 2
IV interior-side surface of the inner pane 2
A-A′ section line

1. A projection assembly at least comprising a light source for p-polarized light and a composite pane that comprises an outer pane with an exterior-side surface and an interior-side surface, an inner pane with an exterior-side surface and an interior-side surface, and a thermoplastic intermediate layer, wherein
the interior-side surface of the outer pane and the exterior-side surface of the inner pane are joined to one another via the thermoplastic intermediate layer,
in at least one first subregion of the composite pane, a reflection layer that is configured to reflect the p-polarized light of the light source is arranged on the interior-side surface of the inner pane and/or on the exterior-side surface of the inner pane,
the interior-side surface of the inner pane is the surface of the composite pane nearest the light source for p-polarized light,
at least one opaque cover layer is arranged at least in a second subregion of the composite pane on the exterior-side surface of the outer pane, on the interior-side surface of the outer pane, on the exterior-side surface of the inner pane, and/or on the interior-side surface of the inner pane, a distance of the reflection layer from the light source is less than a distance of the opaque cover layer from the light source, and a projection of the first subregion into a plane of the second subregion is at least partially congruent therewith, and wherein
the reflection layer includes at least one metal carbide-based layer.

2. The projection assembly according to claim 1, wherein the reflection layer is arranged directly adjacent the surroundings on the interior-side surface of the inner pane.

3. The projection assembly according to claim 1, wherein the reflection layer reflects at least 5% of the p-polarized light in a wavelength range from 450 nm to 650 nm incident on the reflection layer.

4. The projection assembly according to claim 1, wherein the light source for p-polarized light is a display.

5. The projection assembly according to claim 1, wherein the projection of the first subregion into the plane of the second subregion is entirely within the second subregion areally.

6. The projection assembly according to claim 1, wherein at least one opaque cover layer is arranged at least partially in a circumferential edge region of the composite pane.

7. The projection assembly according to claim 1, wherein at least one opaque cover layer in the form of an opaque masking print is arranged on the interior-side surface of the outer pane and/or on the exterior-side surface of the inner pane.

8. The projection assembly according to claim 1, wherein the metal carbide-based layer contains at least 95 wt.-% of one or more metal carbides.

9. The projection assembly according to claim 1, wherein the metal carbide-based layer has a thickness of 10 nm to 100 nm.

10. The projection assembly according to claim 1, wherein the reflection layer includes at least one dielectric layer, which is placed above the metal carbide-based layer.

11. The projection assembly according to claim 10, wherein the dielectric layer is an optically low-refractive-index layer with a refractive index of less than 1.6.

12. The projection assembly according to claim 11, wherein the dielectric layer includes silicon oxide.

13. The projection assembly according to claim 9, wherein the dielectric layer has a thickness of 50 nm to 200 nm.

14. The projection assembly according to claim 1, wherein the reflection layer includes an organic protective layer, which is placed above the metal carbide-based layer or the dielectric layer and is directly adjacent the surroundings.

15. A method for producing a projection assembly according to claim 1, the method comprising:
a) providing an outer pane, an inner pane, and a thermoplastic intermediate layer,
b) applying at least one opaque cover layer in at least one second subregion (B) on the exterior-side surface of the outer pane, on the interior-side surface of the outer pane, on the exterior-side surface of the inner pane, and/or on the interior-side surface of the inner pane,
c) placing at least the inner pane, the thermoplastic intermediate layer, and the outer pane together in this order to form a layer stack,
d) laminating the layer stack composed of at least the inner pane, the thermoplastic intermediate layer, and the outer pane to form a composite pane,
e) applying a reflection layer to at least one first subregion of the interior-side surface of the inner pane and/or the exterior-side surface of the inner pane, and
f) orienting a light source for p-polarized light relative to the composite pane such that the p-polarized light of the light source can strike the reflection layer,
wherein step e) can take place before, during, or after steps a) through d), but, if there is an opaque cover layer on the interior-side surface of the inner pane, takes place after application of the opaque cover layer.

16. The projection assembly according to claim 3, wherein the reflection layer reflects at least 10% of the p-polarized light in a wavelength range from 450 nm to 650 nm incident on the reflection layer.

17. The projection assembly according to claim 4, wherein the display is an LCD display, LED display, OLED display, or electroluminescent display.

18. The projection assembly according to claim 4, wherein the p-polarized light strikes the composite pane at an angle of incidence of 55° to 80°.

19. The projection assembly according to claim 8, wherein the one or more metal carbides comprise chromium carbide, titanium carbide, zirconium carbide, hafnium carbide, molybdenum carbide, and/or tungsten carbide.

20. The projection assembly according to claim 9, wherein the metal carbide-based layer has a thickness of 15 nm to 70 nm.
